(19) United States
(12) Patent Application Publication
(10) Pub. No.: US 2016/0356611 A1
(43) Pub. Date: Dec. 8, 2016

(54) SYSTEMS AND METHODS OF FLEXIBLE PAYMENTS FOR COMMUTE MODIFICATION

(71) Applicant: eBay Inc., San Jose, CA (US)

(72) Inventors: Dane Glasgow, Los Altos, CA (US); Matthew Bret MacLaurin, Santa Cruz, CA (US); David Ramadge, San Jose, CA (US); Corinne Elizabeth Sherman, San Jose, CA (US); Anthony Shah, Santa Clara, CA (US); Theodore James Dziuba, San Mateo, CA (US); Josephine Pang, San Francisco, CA (US); Justin VanWinkle, San Jose, CA (US)

(21) Appl. No.: 14/730,839

(22) Filed: Jun. 4, 2015

(51) Int. Cl. G01C 21/34; G08G 1/07; H04L 29/06

(52) U.S. Cl. CPC G01C 21/34; H04L 67/42; G08G 1/07

(57) ABSTRACT

In various example embodiments, systems and methods for enabling users to modify elements of a traffic commute are presented. For example, one embodiment involves a server computer receiving a bid value and a commute path from a client device. The server computer analyzes the received information to identify an available commute modification associated with the commute path, makes and verifies a modification in communication with traffic devices such as a street light if the bid is accepted, and then informs the client device that the modification impacting the user's traffic commute was accepted. In certain embodiments, different groups of users with different commutes associated with conflicting commute modifications bid against each other.

### TECHNICAL FIELD

Embodiments of the present disclosure relate generally to traffic control systems coupled with payment and bidding systems that may be integrated within acceptable control modifications to the traffic control systems.

### BACKGROUND

An individual vehicle commute is controlled by many different factors. The available roads, other vehicles on the road, and traffic control systems all impact travel time for a particular commute. In many environments, the traffic control systems, which include streetlights, speed limits, and other systems for regulating vehicles on the road, are designed and managed in an inflexible manner even when some elements of such control systems are programmable and adjustable within certain guidelines. Modifications to such systems are typically performed in response to traffic studies that may use road sensors, cameras, or human observation to identify potential changes to a system. Such feedback mechanisms are slow and resource-intensive.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a networked system, according to some example embodiments.

FIG. 2 illustrates a method of flexible payments for commute modification, according to some example embodiments.

FIG. 3 illustrates components of a commute modification system, according to some example embodiments.

FIG. 4 illustrates aspects of a commute path and traffic devices, in accordance with some example embodiments.

FIG. 5 illustrates aspects of a commute path and traffic devices, in accordance with some example embodiments.

FIG. 6 illustrates aspects of a commute path and traffic devices, in accordance with some example embodiments.

FIG. 7 is a flow diagram illustrating operations of a method for competitive bidding with flexible payments for commute modification, according to some example embodiments.

FIG. 8 is an interface diagram illustrating an example user interface elements, according to some example embodiments.

FIG. 9 is an interface diagram illustrating aspects of an example commute modification application, according to some example embodiments.

FIG. 10 is a block diagram illustrating an example of a software architecture that may be installed on a machine capable of implementing the methods and modules of the user interface element generation system, according to some example embodiments.

FIG. 11 illustrates a diagrammatic representation of a machine in the form of a computer system within which a set of instructions may be executed for causing the machine to perform any one or more of methods of the user interface element generation system, according to an example embodiment.

The headings provided herein are merely for convenience and do not necessarily affect the scope or meaning of the terms used.

### DETAILED DESCRIPTION

Embodiments described herein relate generally to traffic control systems and payment and bidding systems that may be integrated within acceptable variations within the operation of a traffic control system.

Systems described herein function, at least in part, through applications operating on a device belonging to a commuter, such as a smartphone or a computer integrated with the commuter's vehicle. A commute, as described herein, refers to any vehicle travel from one place to another, including trips repeated on different days such as a commute to work, or single vehicle trips that are not regularly repeated by a particular commuter. Individual commuters specify how much they are willing to pay to speed up their current commute. This information is provided to a server computer of the commute modification system, which has access to systems that control traffic devices that impact the commuter's travel time. One example of such traffic devices includes traffic lights and the systems that control timing for stop and go indicators presented by traffic lights. The system uses the information from the commuter's device as well as any limitations on the accessible traffic system to determine whether any suitable commute modification is available to benefit the commuter. If there are available changes, the server computer communicates with the traffic devices to implement the changes. The server computer then processes any payments associated with the changes, and sends a communication verifying the changes and the payment to the commuter's device.

For example, in one embodiment, a first commuter is starting to travel down a stretch of road with several street lights in a row. The first commuter has a standing input with the commute system that the commuter is willing to pay $10 to speed the commute. As the user approaches the intersections, the system determines the aggregate amount offered by all system users traveling in both directions along the stretch of road during a particular time window or set of time windows. A standard timing may be set to optimize traffic in both directions, with cars in both directions traveling at the speed limit expected to stop multiple times. The system may determine that the aggregate amount offered in the first commuter's direction is greater than the aggregate amount offered in the opposite direction, and the system may then verify that a timing adjustment for the lights on the relevant stretch of road is allowed. The system then communicates to the timing control systems of the street lights to adjust the timing so that the first commuter will be able to drive down the road at the speed limit with no expected stops due to the timing of the street lights being matched to the commuter's travel path and direction. The system verifies the timing adjustments and payment, and then informs the first commuter that the adjustment has been made and the user's payment has been processed. The same payment and notification processes are performed for any other system users that made bids and were traveling in the same direction on the road within a timing window that allowed travel without stop. The traffic timing may then return to a default, or have another adjustment applied based on a new set of bids and a new timing window.

As described below, such a system for commute modification may be integrated with other commute aspects in addition to traffic light timing adjustments, including route selection, special toll or commuter lane payments, payment systems set for point or reward systems as an alternate to currency payments, or other such elements of a commute modification system.

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

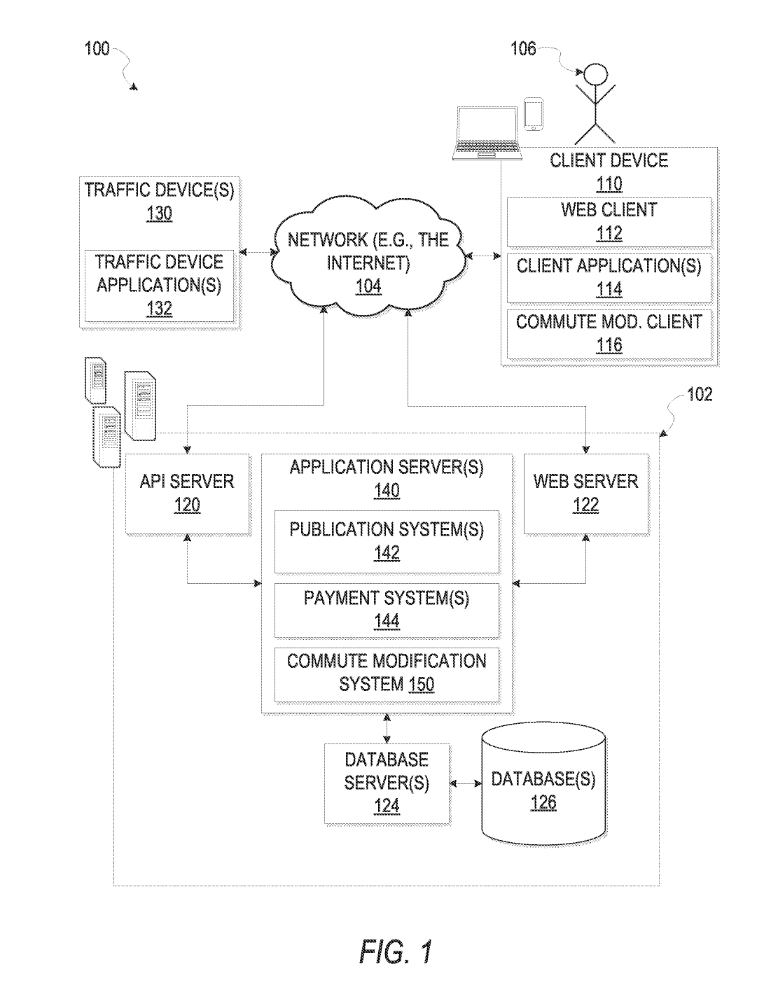

With reference to FIG. 1, an example embodiment of a high-level client-server-based network architecture 100 is shown. A networked system 102, in the example forms of a network-based marketplace or payment system, provides server-side functionality via a network 104 (e.g., the Internet or wide area network (WAN)) to one or more client devices 110. FIG. 1 illustrates, for example, a web client 112 (e.g., a browser, such as the Internet Explorer® browser developed by Microsoft® Corporation of Redmond, Wash. State), client application(s) 114, and a programmatic client shown as commute modification client 116 executing on client device 110.

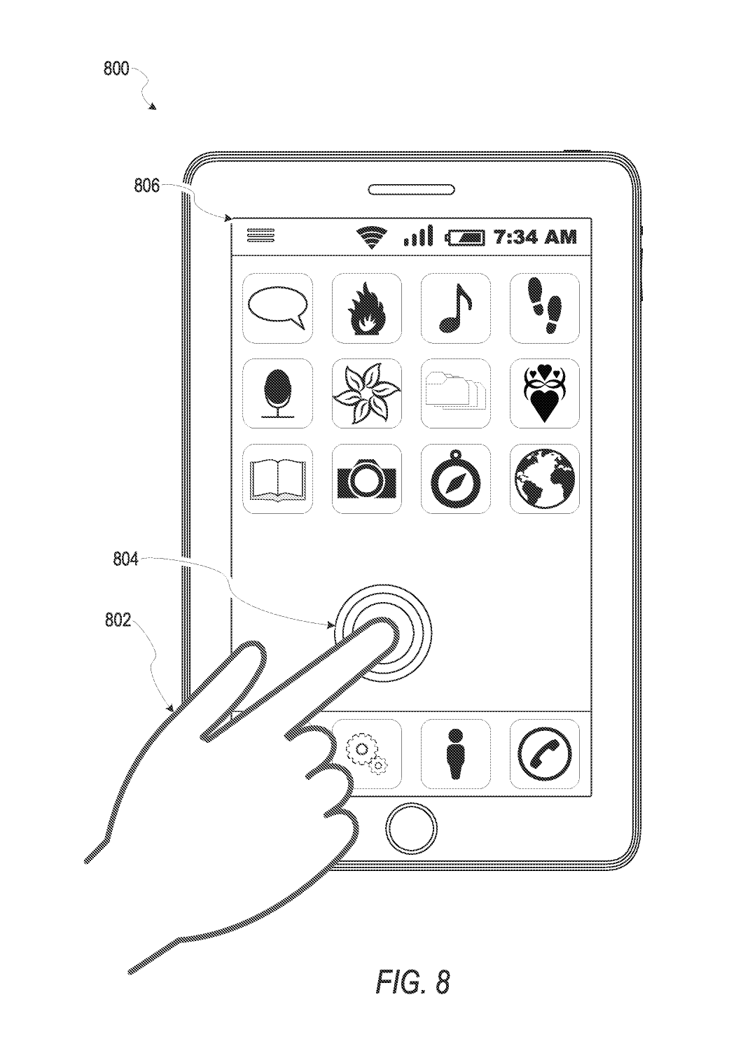

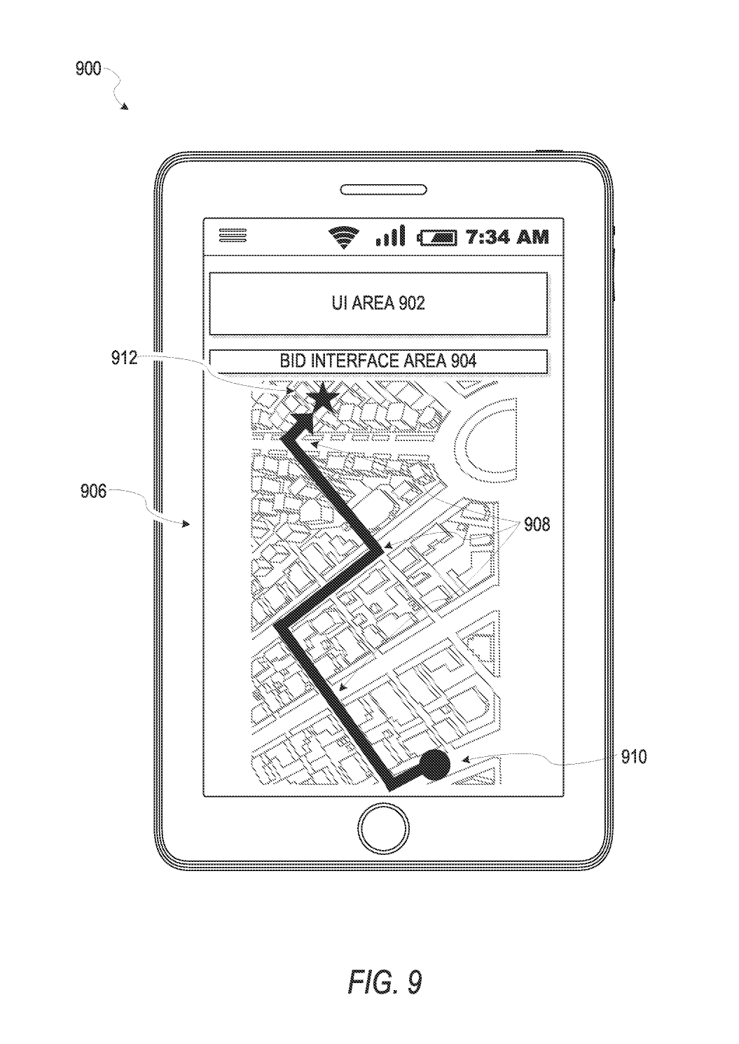

The client device 110 may comprise, but is not limited to, a mobile phone, an automobile navigation system or any such device integrated with a vehicle as a vehicle computing system, a desktop computer, laptop, portable digital assistant (PDA), smart phone, tablet, ultra book, netbook, multi-processor system, microprocessor-based or programmable consumer electronics, or any other communication device that a user may utilize to access the networked system 102. In some embodiments, the client device 110 may be similar to devices 800 or 900 of FIGS. 8 and 9, and may comprise a display module to display information (e.g., in the form of user interfaces). In further embodiments, the client device 110 may comprise one or more of a touch screens, accelerometers, gyroscopes, cameras, microphones, global positioning system (GPS) devices, and so forth. The client device 110 may be a device of a user that is used to perform a transaction involving digital items within the networked system 102. In one embodiment, the networked system 102 is a network-based marketplace that responds to requests and bids for commute modifications available on the network-based marketplace, and manages payments for these marketplace transactions. One or more users 106 may be a person, a machine, or other means of interacting with client device 110. In embodiments, the user 106 is not part of the network architecture 100, but may interact with the network architecture 100 via client device 110 or another means.

Each of client device 110 may include one or more applications (also referred to as “apps”) such as, but not limited to, a web browser, messaging application, electronic mail (email) application, an e-commerce site application (also referred to as a marketplace application), and the like. In some embodiments, if the e-commerce site application is included in a given one of the client device 110, then this application is configured to locally provide the user interface and at least some of the functionalities with the application configured to communicate with the networked system 102, on an as needed basis, for data and/or processing capabilities not locally available (e.g., access to a database of items available for sale, to authenticate a user, to verify a method of payment, etc.). Conversely if the e-commerce site application is not included in the client device 110, the client device 110 may use its web browser to access the e-commerce site (or a variant thereof) hosted on the networked system 102.

In example embodiments, the user 106 is not part of the network architecture 100, but may interact with the network architecture 100 via the client device 110 or other means. For instance, the user provides input (e.g., touch screen input or alphanumeric input) to the client device 110 and the input is communicated to the networked system 102 via the network 104. In this instance, the networked system 102, in response to receiving the input from the user, communicates information to the client device 110 via the network 104 to be presented to the user. In this way, the user can interact with the networked system 102 using the client device 110.

One or more portions of network 104 may be an ad hoc network, an intranet, an extranet, a virtual private network (VPN), a local area network (LAN), a wireless LAN (WLAN), a WAN, a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

An application program interface (API) server 120 and a web server 122 are coupled to, and provide programmatic and web interfaces respectively to, one or more application servers 140. The application server(s) 140 may host one or more publication system 142 and payment system 144, each of which may comprise one or more modules or applications and each of which may be embodied as hardware, software, firmware, or any combination thereof. The application server(s) 140 are, in turn, shown to be coupled to one or more database server 124 that facilitate access to one or more information storage repositories or database(s) 126. In an example embodiment, the database(s) 126 are storage devices that store information to be posted (e.g., publications or listings of available commute modifications, or systems that interact with user-provided path details to list available commute modifications) to the publication system(s) 142. The database(s) 126 may also store digital item information in accordance with example embodiments.

Additionally, a third party traffic device application 132, executing on traffic device(s) 130 or a computing system that is part of a traffic device control system and thus integrated with traffic device(s) 130, is shown as having programmatic access to the networked system 102 via the programmatic interface provided by the API server 120. In other embodiments, multiple layers of security and access control may be used to prevent traffic device(s) 130 from being accessed in an unauthorized fashion, or from being adjusted with parameters outside of acceptable operation standards. For example, traffic device application(s) 132, utilizing information retrieved from the networked system 102, adjustments to timing of a traffic light within system standards (e.g., limits on how long a light can be red in a certain direction).

The publication system(s) 142 may provide a number of publication functions and services to users 106 that access the networked system 102. The payment system(s) 144 may likewise provide a number of functions to perform or facilitate payments and transactions. For example, various types of bids may be available, including pre-approved bids, periodic bid limits, modification availability alerts, and other such aspects of a system where users may be bidding against each other under time-sensitive and variable conditions. While the publication system(s) 142 and payment system(s) 144 are shown in FIG. 1 to both form part of the networked system 102, it will be appreciated that, in alternative embodiments, each system 142 and 144 may form part of a payment service that is separate and distinct from the networked system 102. In some embodiments, the payment system(s) 144 may form part of the publication system(s) 142.

A commute modification system 150 may provide functionality operable to analyze bids and commute paths received from users, and to identify commute modifications available in the system that match the commute paths received from users. Options to generate a commute modification based on the analysis and acceptance of a user's bid may be performed, along with communication with traffic device(s) 130 via network 104 to modify commute elements (e.g., traffic light timing). Commute modification system 150 may then process payments associated with user bids using payment system(s) 144, and can notify client device 110 that a modification has been confirmed and a payment associated with a bid has been processed. Each of these processes may involve using database server(s) 124 with database(s) 126 to identify groups of user bids from client devices such as client device 110, and to verify commute modification availability using information stored in databases(s) 126.

Further, while the client-server-based network architecture 100 shown in FIG. 1 employs a client-server architecture, the present inventive subject matter is of course not limited to such an architecture, and could equally well find application in a distributed, or peer-to-peer, architecture system, for example. The publication system(s) 142, payment system(s) 144, and commute modification system 150 could also be implemented as standalone software programs, which do not necessarily have networking capabilities.

The web client 112 may access the various publication and payment systems 142 and 144 via the web interface supported by the web server 122. Similarly, the programmatic client implementation of a commute modification client 116 accesses the various services and functions provided by the publication and payment systems 142 and 144 via the programmatic interface provided by the API server 120. FIG. 9 illustrates one example of a user interface for a commute modification client 116.

Additionally, a traffic device applications 132, executing on a third party server(s) 130, is shown as having programmatic access to the networked system 102 via the programmatic interface provided by the API server 120. For example, the third party traffic device application 132, utilizing information retrieved from the networked system 102, may support one or more features or functions on a website hosted by a third party managing traffic device(s) 130. In some embodiments, these operations may be integrated with application server(s) 140.

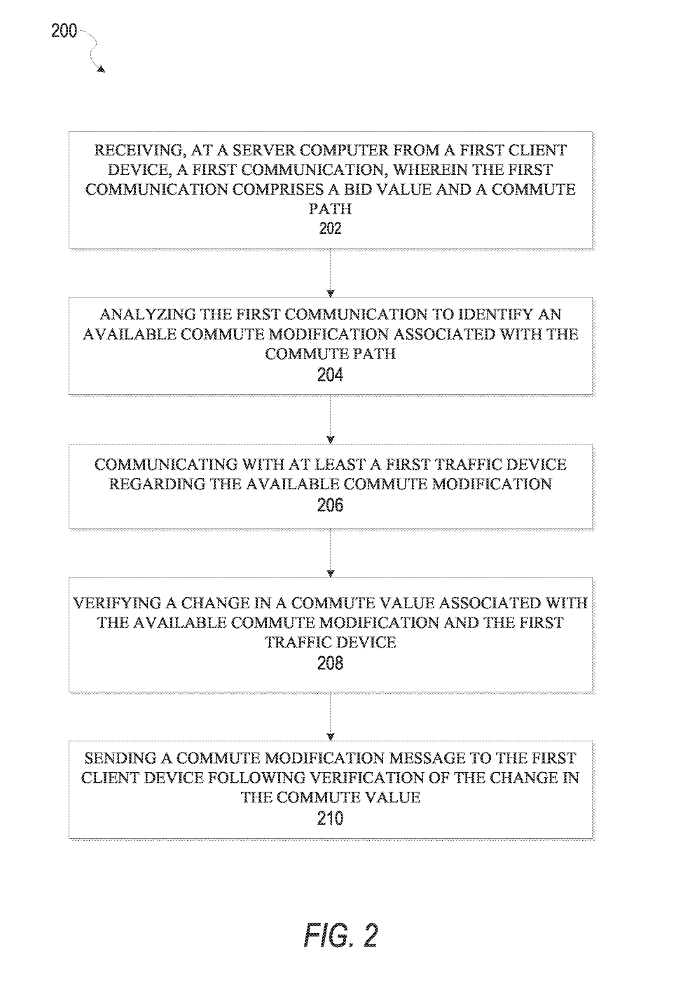

FIG. 2 then describes one example embodiment of a method 200 for providing commute modification with flexible payments. For the purposes of illustration, the method 200 is described with respect to network architecture 100 of FIG. 1. It is to be understood, however, that embodiments similar to method 200 could be implemented in other systems, and that other methods are possible within the scope of the present innovations.

Method 200 begins with operation 202 receiving, at a server computer such as an application server 140, from a first client device 110, a first communication, wherein the first communication comprises a bid value and a commute path. In various embodiments, this communication may be structured in different ways. In certain embodiments, the bid value and the commute path may be sent as part of a single communication. In other embodiments, the commute path and the bid value may be sent separately. In some embodiments, for example, the commute path may be estimated or selected from multiple possible commute paths based on a current position, a destination position, a set of road or map information, and additional commute information such as real-time traffic data, road construction data, accident delay data, or any other such data that may impact a commute path. In still further embodiments, the commute path may be estimated from previous travel data recorded by a device using position sensors or global positioning system (GPS) data recorded by a client device.

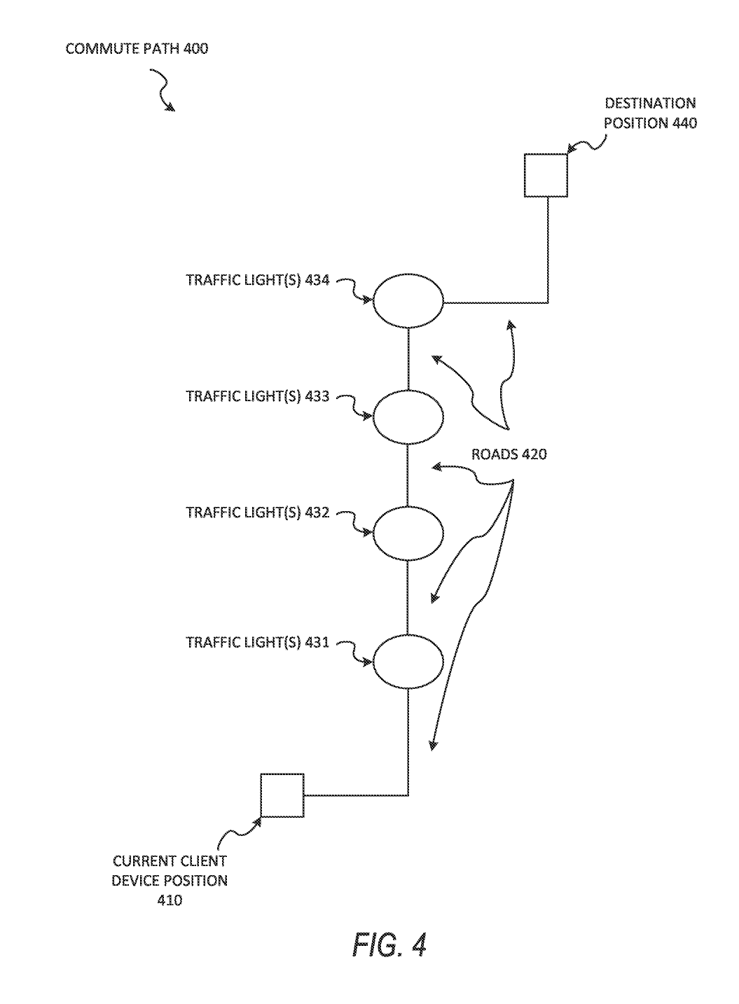

In some embodiments, the bid value may also be communicated in different formats. For example, an initial bid value may be sent, and a response indicating that a current opposing bid is currently greater may be received, with an option to increase a user's bid value. This may continue until a set of commute modifications is fixed or a client device has reached a commute position where any modification will have a minor impact on the remaining commute path. This may, for example, be a value set by a user during a registration process. For example, a user may submit a bid indicating that the bid is valid for commute modifications that are estimated to reduce a commute time by a certain period of time, such as 1 minute, 5 minutes, or another such time period. Modifications estimated to reduce a user's commute path by less than this amount will not be considered as relevant to the user's bid. Details of bid values and commute paths that may be received as part of a communication are described in more detail below with respect to FIGS. 4-6.

Method 200 then continues with operation 204 analyzing, by the application server 140, the first communication to identify an available commute modification associated with the commute path. In various embodiments, this involves identifying details associated with a commute path, such as particular roads and traffic devices associated with the commute path. This may also involve determining current settings associated with the traffic devices along the commute path, and acceptable variations in the settings. This information may be stored in a database 126, or may be accessed by contacting traffic devices 130 directly. The acceptable variations in the settings may be established by an operator of the one or more traffic device 130, or may be set by results associated with certain traffic settings. For example, some embodiments may include both traffic devices 130 that regulate traffic, such as street lights, as well as traffic devices 130 that sense traffic characteristics, such as speed, waiting time, or stopped wait length. For example, some traffic devices 130 may have a limit on the amount of time any direction of an intersection may be presented with a red light. Some traffic devices 130 may have a limit on the number of cars or the backup distance or length of the waiting line of cars at an intersection in order to prevent back-ups across multiple intersections. Some traffic devices 130 may have multiple combinations of such limits on the potential variations available for one or more traffic devices 130, either alone or in combination with other traffic devices.

One commute modification is a change in traffic light timing patterns along a continuous stretch of road to allow a vehicle or group of vehicles to pass through multiple street lights without stopping or slowing. Inherent in the structure of many environments, such as urban environments arranged into blocks with street lights at each block, it is not possible for vehicles traveling in both directions on a single street with stop lights at each block to travel without stopping unless there is no cross traffic parallel to the street. In order for traffic in one direction to proceed without stopping while still providing a break for cross traffic to move, the lights may be configured in a “wave” timing to allow a group of cars traveling at a certain speed to proceed through a sequence of traffic lights without interruption. Cars traveling in the opposite direction of such a wave, however, will encounter red lights where the opposite direction vehicles must stop in order to let cross traffic flow.

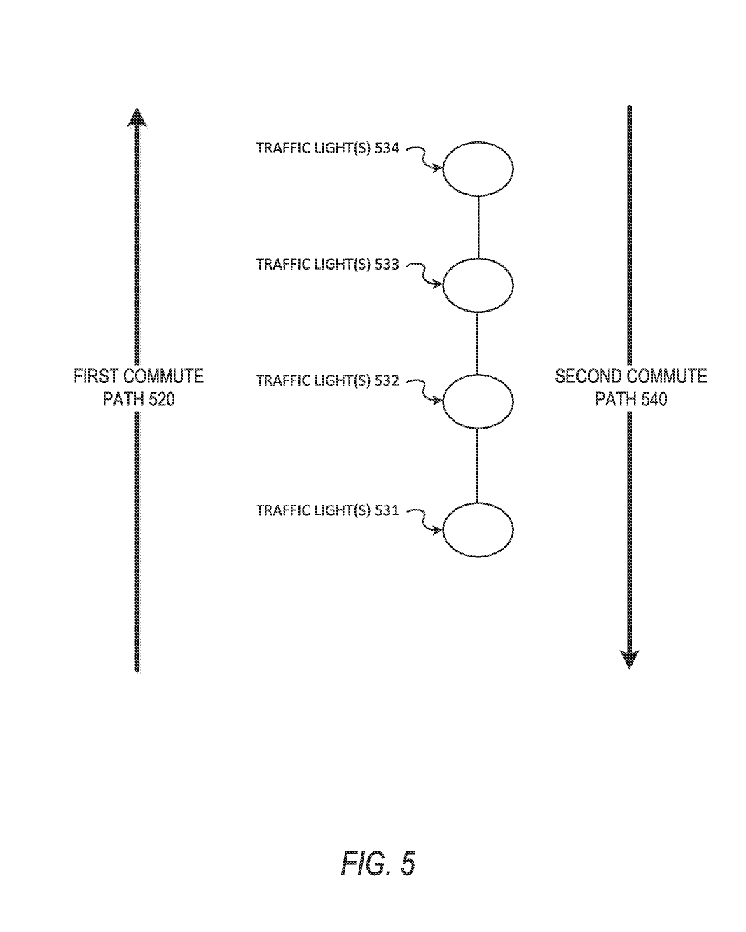

Some embodiments described herein relate to groups of traffic devices 130 where the direction of the “wave” timing for the group of street lights may be adjusted to allow traffic in either direction (but only one direction at a time) to proceed at a set speed through the lights without stopping. A timing adjustment in such an embodiment relates to setting the direction in which stops will not occur (or a lesser number of stops will occur) and an opposing direction in which a greater number of stops will occur. Additional details and descriptions of such an embodiment is discussed below with respect to FIGS. 4 and 5.

Method 200 then proceeds with operation 206 communicating, by the application server 140 computer, with at least a first traffic device regarding the available commute modification. In certain embodiments, this may involve a direct communication from application server 140 to a device such as an individual street light of traffic devices 130. In many embodiments, however, multiple traffic devices 130 will be integrated into a system that may have centralized security and control for managing traffic devices 130, preventing a traffic device 130 operation from executing outside of legal limits and setting an acceptable set of limitations associated with the traffic devices 130 within the traffic system.

In such embodiments, a centralized traffic device application 132 may present an interface for managing many traffic devices 130 to commute modification system 150 of the application server 140. In such an embodiment, rather than application server 140 controlling individual traffic devices 130, a separate centralized traffic device application 132 provides timing adjustment requests. The traffic device application 132 then verifies operation rules for safety and security, and communicates verification that the modification was accepted.

If a modification is accepted or traffic devices 130 are under direct control of application server 140, then method 200 proceeds with operation 208, verifying, by the application server 140 computer, that the change from the available commute modification has been implemented. This verification may be a received response from traffic device(s) 130 or traffic device application(s) 132 indicating a commute value or a change in the commute value associated with the available commute modification and the first traffic device. In certain embodiments where one group of users is bidding to maintain a current set of commute values and another group of users is bidding to change the current set of commute values associated with traffic device(s) 130, a commute modification may not involve any changes to a system, but may simply involve maintaining a current set of timings or settings for traffic device(s) 130. In such an embodiment, the communication of operation 206 and verification of operation 208 may simply relate to checking and maintaining a set of commute settings that is already in place.

In other embodiments, an intermediate set of commute settings may exist that, for example, provide an equal amount of delay to commuters traveling in opposite directions. In the absence of a user that has presented a bid for a commute modification, such an embodiment may return to default intermediate settings. In other embodiments, the default settings may depend on a time of day or historical variations in traffic patterns that have been observed and used to create dynamic settings for traffic device(s) 130. In any such embodiment, acceptable variations from the current default may be identified, and bids may be accepted for both variations and maintenance of the current settings. In some embodiments, given a set of aggregate bids to change the current settings and a larger set of aggregate bids to maintain the current settings, the system may accept and process payments associated with maintaining the current settings and reject the bids associated with changing the current settings.

Method 200 then includes operation 210 sending, from the application server 140 computer, a commute modification message to the first client device 110 following verification of the change in the commute value. Such a commute modification message may provide details of the available commute modification, alternate modifications that may have caused delays for the user 106 of the client device 110, and a summary of charges.

In different embodiments, a flexible payment process is associated with commute modification in different ways. In certain embodiment, an account associated with client device 110 is be pre-loaded with funds. In some embodiments, a credit card is associated with client device 110, and a payment is authorized from the credit card before a final modification is made or before a notification is sent to client device 110 notifying user 106 of the commute modification. In certain embodiments, if a client device 110 is associated with a certain number of commute modifications where payment fails or is reversed, an account and system functionality for the client device 110 is suspended or a deposit amount is used for client device 110 to be allowed to send communications with bids and commute paths to application server(s) 140.

In other embodiments, a system may operate using non-currency points, or using a point system that has some possible conversion of currency to points, but may also provide other methods of accruing points which are not convertible back to currency. For example, when a user's bid fails, or when a user is allowing a system to use client device 110 to gather commute information or supporting data, an account associated with client device 110 may accrue points or currency. Additionally, in some embodiments, a system may offer a commute modification that has certain users take an alternate, slower route to decrease congestion on a primary, fastest route that includes other client devices and users that are bidding or making payments to decrease their commute time. Some percentage of bid points or bid amounts may be provided to users on the same path to take an alternate path in certain embodiments. In such embodiments, other gamification methods may be applied to the system to encourage some users 106 to accept benefits other than later use of points or currency in the system for an improved commute (e.g., a decreased commute time).

While method 200 described above includes a particular set of operations, other embodiment methods may include the operations described in a different order, or with additional operations between the operations described above. Additionally, certain embodiments may include operations that precede the first operation 202 of method 200, and that may also include operations that follow the final operation 210 of method 200.

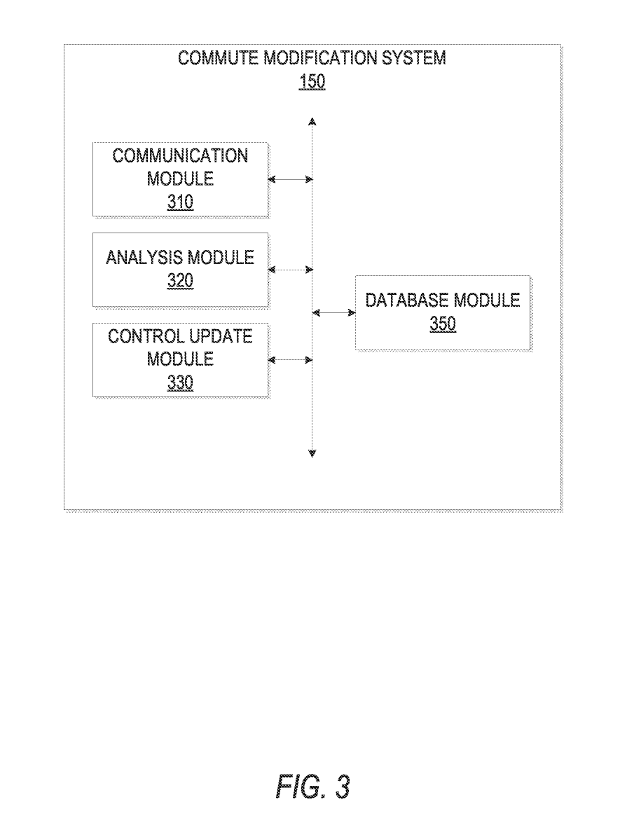

FIG. 3 is a block diagram illustrating components of the commute modification system 150, according to some example embodiments. The commute modification system 150 is shown as including communication module 310, analysis module 320, control update module 330, and database module 350. Any one or more of the modules described herein may be implemented using hardware (e.g., one or more processors of a machine) or a combination of hardware and software. For example, any module described herein may configure a processor (e.g., among one or more processors of a machine) to perform any of the operations for which that module is designed. Moreover, any two or more of these modules may be combined into a single module, and the functions described herein for a single module may be subdivided among multiple modules. Furthermore, according to various example embodiments, modules described herein as being implemented within a single machine, database 126, or device may be distributed across multiple machines, databases 126, or devices.

In the embodiment of commute modification system 150 shown by FIG. 3, communication module 310 may perform a variety of communication operations including operations to receive communications from any number of client devices. Communication module 310 may thus perform operations similar to operation 202 of method 200.

Analysis module 320 processes information from client device communications, and also accesses information related to available commute modifications. The analysis of client device communications may involve bidding processes and comparisons between different groups of client communications that share all or part of a particular commute path in a shared direction. The identification of users and client devices that share a commute path during a particular time frame that would be impacted by a set of commute modifications is performed by analysis module 320 as part of the processing of client device communications. For example, a first communication and a second communication may be received from different client devices which are in different positions, but with a shared destination. An analysis of the positions and the timing of the communications may indicate that vehicles associated with the client devices are expected to be traveling through certain traffic lights within a shared timing window. The shared timing window is, in some embodiments, an expected timing for a vehicle to pass a traffic light without stopping after a commute value is changed for the traffic light to reduce the commute time of the vehicles. Commute path data received from different vehicles that share a timing window as described above may be referred to as complementary commute paths that have complementary commute modifications, since some or all of the commute modifications that reduce the commute time of one vehicle will also reduce the commute time of the other vehicle. Bids received as part of the communications from the first and the second client devices may be aggregated in order to influence the timing of traffic lights associated with the commute, since the analysis module 320 has determined that commute modifications are complementary and will positively impact vehicles associated with both client devices.

The analysis module 320 may also identify vehicles within the shared timing window traveling in opposite directions, or along conflicting paths. Commute paths where only one path is expected to receive a benefit from a commute modification may be referred to herein as non-complementary, and commute modifications that influence one vehicle's commute but not another vehicle's commute may be referred to as non-complementary commute modifications. In the case of a commute path with vehicles traveling in opposite directions, the analysis module 320 may identify a timing window for the entire path involving multiple traffic devices, and may aggregate all bids from client devices associated with vehicles expected on the path within the timing window to determine which commute modifications are associated with the largest bid.

In order to determine that the commute modifications are available, the analysis module 320 may additionally communicate with a database module 350 to identify which traffic devices are part of the shared commute path, and to retrieve, from the database module 350, the acceptable variations in timing or commute values associated with traffic devices along the shared commute path. In some embodiments, the database module 350 includes map information along with traffic light details for intersections on the map. The database module in such an embodiment will further contain information on the default light timings, and the acceptable modifications for each traffic light. In other embodiments, rather than retrieving the information on traffic devices from a local database module 350, the communication module 310 may be used to interact with traffic devices or traffic device applications to retrieve the information about acceptable modifications.

After the analysis module 320 has identified vehicles within a timing window associated with available commute modifications and associated with the largest aggregate bid, then control update module 330 implements the timing changes in communication with one or more traffic device 130. This process may be similar to operations 206, 208, and 210 of method 200, where the control update module 330 requests timing changes in communication with traffic devices 130, verifies that the commute modifications are implemented, and then sends a message to the client devices 110 verifying that the commute modification was implemented. In some embodiments, control update module 330 may use a set of communication addresses (e.g., internet protocol addresses) from database module 350 to communicate with traffic devices 130 in order to request the commute modifications.

Additionally, any module above or any module in other embodiments may communicate with modules such as payment modules, map modules, vehicle position or location assistance modules, or other modules to process payments, update details of commute paths as vehicles move, or to perform any other processes for commute modifications associated with flexible payments.

FIG. 4 then illustrates a commute path 400, along with additional details of the commute path 400 which may be gathered from a database system, a map system, or by communication with traffic device applications that control a traffic system. Commute path 400 as shown includes current client device position 410 and destination position 440, and a set of roads 420 that may be used by a vehicle to travel from current client device position 410 to destination position 440.

Current client device position 410 may be a position determined by a GPS system, a network assisted location system, a set of location sensors, or any other such system of a client device, e.g., client device 110. This information may then be communicated to a server computer as part of a communication from a client device. The destination position 440 may be a map position or a set of longitude and latitude coordinates entered by a user or selected by a client device application based on previous movement of a client device. For example, if a client device records a movement to a destination position at roughly 9 AM on a significant percentage of week-days, the device may automatically identify destination position 440 on any given week-day morning, with a user interface option to adjust the location of destination position 440 within a commute modification application.

Traffic lights 431-434 are sets of traffic lights at intersections which have controllable timings, and where each set of lights controls traffic at a multi-directional stop. In some embodiments, information about traffic lights 431-434 is stored in a database of a commute modification system such as database module 350 of commute modification system 150. This information may include default timing information for lights transitioning from green to yellow to red and back to green. This information may include details about the number of lights and directions present at an intersection. This information may include limits on possible modifications to the timing not only for each traffic light at an intersection, but for all lights 431-434 at all intersections on commute path 400.

FIG. 5 then illustrates aspects of timing consideration for opposing non-complementary commute paths, shown as first commute path 520 and second commute path 540. The first commute path 520 involves a vehicle traveling from an intersection including traffic lights 531, to an intersection containing traffic lights 532, to an intersection containing traffic lights 533, to an intersection containing traffic lights 534. This first commute path 520 may be only a portion of a larger commute path for a client device.

The second commute path 540 is in the opposite direction of the first commute path 520, with a client device beginning at an intersection containing traffic lights 534 and proceeding along the path to traffic lights 531 via traffic lights 533 and 532.

Because intersections containing traffic lights 531-534 will include cross traffic on roads perpendicular to the illustrated commute paths 520 and 540, it will not be possible under some conditions to provide green lights through the entire path for vehicles traveling first commute path 520 and second commute path 540 at the same time. For example, if a first client device on first commute path 520 is provided a green light at traffic lights 531 at the same time that a second client device on second commute path 540 is provided a green light at traffic lights 534, then by the time the first client device reaches traffic lights 534, a red light time for traffic on a perpendicular road at the intersection for traffic lights 534 will likely be exceeded. Similarly, providing a red light and then switching back to a green light by the time the first client device reaches traffic lights 534 may violate a minimum light time at traffic lights 534. In such an environment, the commute modification system chooses one of the two commute paths 520, 540 as a timed path for a commute modification. As described herein, bids received at a commute modification system are aggregated for traffic on first commute path 520 during a first time window, and bids received for traffic on second commute path 540 are also aggregated for an overlapping or identical time window. The larger bid may be accepted to time the lights so that vehicles containing client devices associated with the larger aggregate bid amount do not have to stop at any of traffic lights 531-534.

Additionally, for any given device, the path shown in FIG. 5 may only be a portion of the path from a current device location to a destination. For a single device submitting a bid as part of a communication with a commute modification system, any number of separate portions of a commute path may be considered separately by the system, so that part of a device's commute may be optimized to reduce the device's commute time, while another part may not. In such situations, the bid provided by a client device may be managed in different ways. For example, partial payment of a bid may be provided for partial optimization of a commute path. A payment may be associated with a threshold commute time reduction, so that the entire bid payment is only processed if the threshold commute time reduction is met. In other embodiments, payment may be proportional, so that if only 50% of a target commute time reduction is realized, then only 50% of the bid is processed as a payment. Such payment selections may be managed during the commute or at the beginning of the commute as part of a user interface at a client device running a commute modification application, or such selections may be managed during an account creation an registration process.

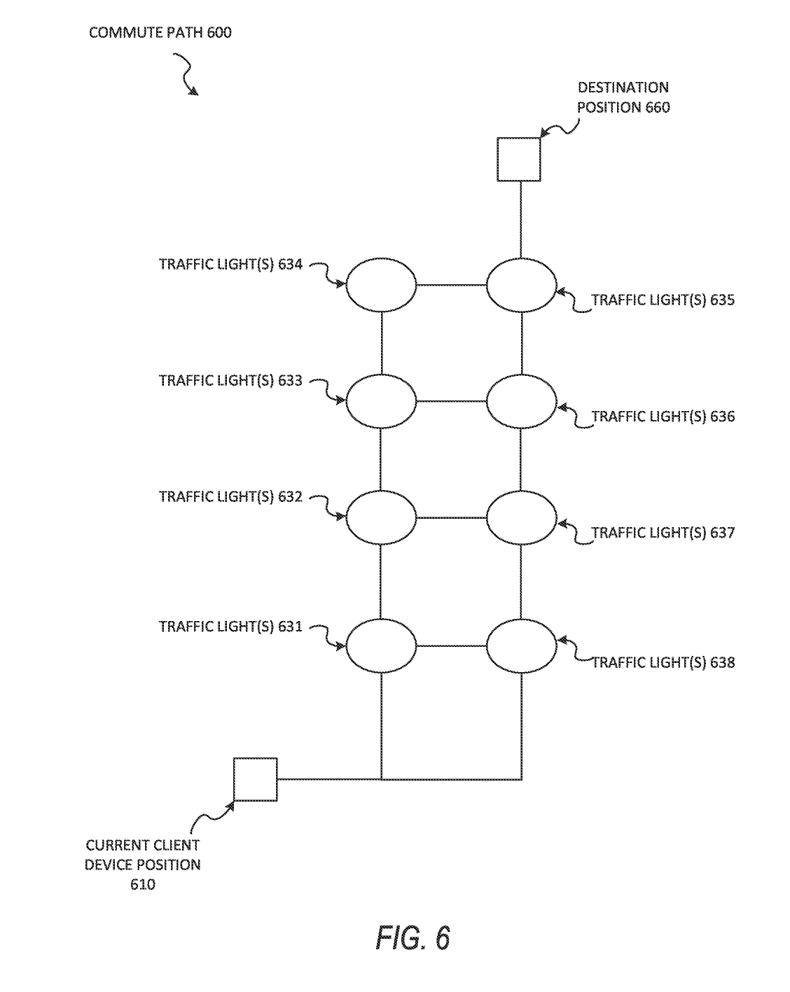

As described above, in various embodiments a commute modification system can make modifications to traffic devices along a single path in order to lower an expected commute time for one or more client devices (e.g., smartphones or vehicle computers) traveling with a user along a single path. Additionally, the system can aggregate bids among conflicts for single paths or traffic devices managing different directions to determine which device will benefit from a lower expected commute time from a commute modification. In addition to management of single paths as illustrated in FIGS. 4 and 5, other aspects of a commute may also be managed in conjunction with the traffic device modifications described in FIGS. 4 and 5. FIG. 6 illustrates aspects of another commute path 600 including multiple possible routes from a current client device position 610 to a destination position 660.

In some embodiments, a commute modification system, such as commute modification system 150, can receive current client device position 610 and destination position 660 as indicators of the commute path 600 in a communication from a client device. In order to reduce the commute time, the analysis of the commute path 600 may include not only timing value modifications for traffic lights 631-638 at associated intersections, but also path information. In such an embodiment, an analysis module, such as analysis module 320, can access information about all possible paths as well as the specific traffic light timing modifications on each path to estimate which path and commute modification combination will provide the greatest commute time reduction to the client device. For groups of client devices in overlapping windows, the system may alternatively attempt to identify paths and sets of traffic light timing modifications that provide the greatest commute time reduction to all bidding client devices, or that provide the greatest commute time reduction that meets a payment threshold for the largest bid amounts. In such an embodiment, multiple groups of client devices with partially conflicting commute paths may each be provided paths and traffic light timing modifications which, while not optimal for either group, provide a benefit for both groups. For example, vehicles traveling from position 610 to position 660 may be routed on a path through the intersections associated with traffic lights 631-635 while the vehicles and associated client devices traveling in the opposite direction, from position 660 to position 610, may be directed along the path including intersections with traffic lights 635-638. Timing conflicts at overlapping traffic lights 635 may be handled by particular timing windows or by determining the largest aggregate bid. If the first group of vehicles has the largest aggregate bid, they may receive traffic light timing that allows uninterrupted travel from position 610 to position 660, while the other group may have to stop at the intersection with traffic lights 635, but may then receive uninterrupted traffic light timing from the intersection with traffic lights 636 to position 610.

Additionally, other embodiments may include other commute modifications. In some embodiments, certain roads on a commute path may be long stretches that include commuter lanes or toll lanes. Some embodiments may include an option for a commute modification system to auction access to a commuter lane or a toll lane based on the bid entered into a client modification application and other system factors. For example, a system may have traffic sensors monitoring toll lanes or commute lanes, and may offer access to users of client devices based on current congestion levels monitored by the traffic sensor devices. In such an embodiment, access to the lane may be analyzed against a bid received from a client device and an expected commute reduction time to determine if the bid will be accepted and used, at least in part, to pay for temporary access to a commuter lane or a toll lane.

Additionally, as described above, in certain embodiments, users may be offered payments or points by the system to modify a user's commute behavior to reduce traffic and commute time for other users. For example, a first user can indicate to a commute modification application that they are willing to take a slower route or forgo use of a commuter lane associated with a high-efficiency vehicle (HEV) status. A system analysis may determine that other users are bidding for a reduced commute time on the same commute path. If the system determines that sufficient impact may be expected, the system may provide the first user and other users with points or compensation in exchange for the first user and any other users taking a slower route. Similarly, the system may manage an exchange of HEV status to provide another vehicle with the right to use a commuter lane in exchange for the owner of the HEV status temporarily giving up the right to drive in the commuter lane. Verification that the first user actually takes an alternate route or refrains from using a commuter lane during a commute may be verified by tracking the user's device. These additional commute modifications can then be used to improve a bidder's expected commute time in addition to the other commute modifications (e.g., traffic light timing modifications) discussed above.

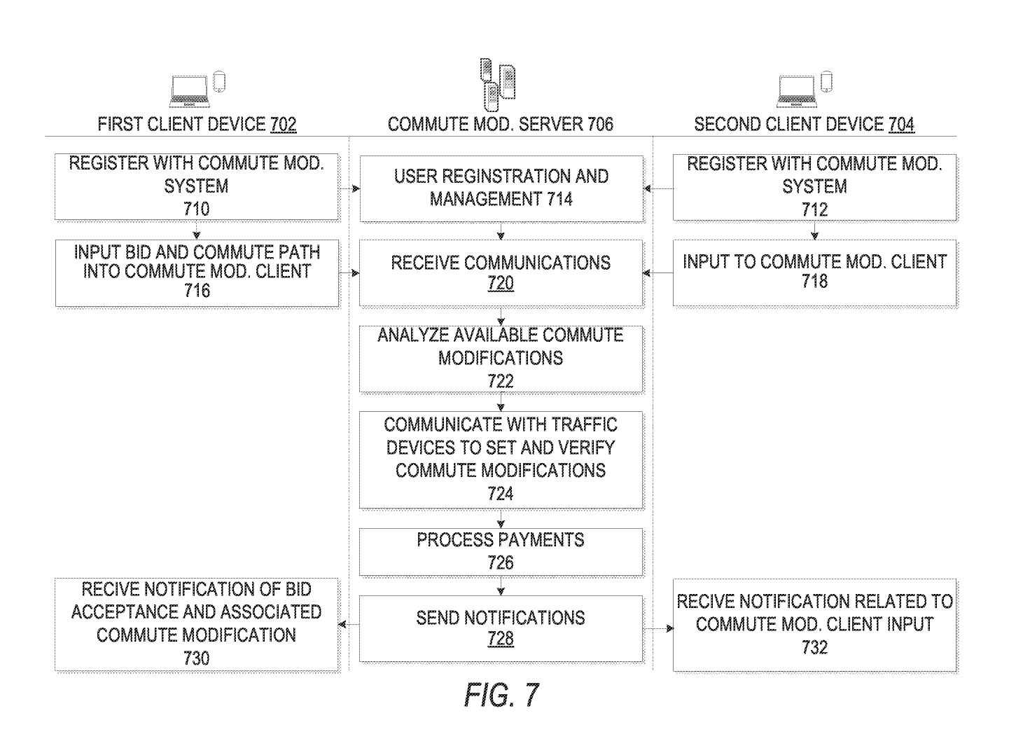

FIG. 7 is a flow diagram illustrating operations of a method for competitive bidding with flexible payments for commute modification according to some example embodiments. The example embodiment of FIG. 7 shows first client device 702, second client device 704, and commute modification server 706 computer. While client devices 702 and 704 are shown with computer and smartphone illustrations, these may be any client device, including any wearable device, any computing device integrated with a vehicle, or other such devices as described above.

Operations 710, 712, and 714 involve client devices 702 and 704 each separately communicating with commute modification server 706 to create separate accounts for different users with a commute modification system, e.g., commute modification system 150. This may include providing personal information associated with the user of an account, details of multiple different client devices which may be associated with an account, payment information, initial bid and commute path information, or any other such information that may be used in an initial setup and registration the computer verification system. While FIG. 7 shows first client device 702 registering the account in operation 710 and performing later steps, it will be understood that a separate client device associated with a single account may perform any operations shown for first client device 702. This also applies to operations shown for the account registered by second client device 704 in operation 712. The registration process may also involve download and installation of a commute modification application such as commute modification client 116.

After initial registration and setting of default or user selected settings, each device 702, 704 can then communicate commute modification requests to commute modification server 706. In operation 716, the first client device 702 accepts an input bid and commute path information at a user interface, and initiates communication to commute modification server 706. Similarly, at operation 718, second client device 704 receives an input, and also initiates a communication to commute modification server 706. The input to the second client device 704 of operation 718 may be a bid and commute path, or may be an offer to adjust a vehicle path in exchange for points or payment, or an offer to provide access to a commute or toll lane based on a right associated with the second client device 704 user's account in exchange for points or a payment as discussed above.

In operation 720, communications from any number of client devices are received at commute modification server 706. Communications may be processed as received, or may be grouped together for processing in batches associated with a particular timeframe. In operation 722 the available commute modifications are analyzed and matched with input bids received for a particular time window. The available commute modifications may include traffic light timing changes associated with commute paths, requests for vehicles associated with devices such as second client device 704 to take alternate routes, transfer of commute lane access rights from second client device 704 to first client device 702, or any other such commute modification available to a system. This may also involve selection of routes from among different routes that may be taken for a particular commute, and analysis of the different commute modifications available to different routes based on the modifications and expected commute time reductions available for each mute. This may also involve analysis of the impact on groups of users operating within overlapping time windows, and the aggregate bid and payment amounts associated with various groups and commute modifications.

In operation 724, commute modifications are selected and implemented by the commute modification server 706. As part of this operation, the commute modification server 706 may communicate with various traffic devices or traffic device systems to request adjustments to traffic device settings and values in order to implement a commute modification. Responses received at commute modification server 706 may be taken as verification that the commute modifications where implemented, or in certain embodiments, the lack of an error response may be taken as verification that the commute modifications where successfully implemented.

In operation 726, payments associated with bids from client devices for successfully implemented commute modification processes may be processed to verify payment. In certain embodiments, payments may be processed after a client device has been tracked to a destination, with an expected commute modification impact compared to an actual commute time reduction. In certain embodiments, payments may only be processed if an actual commute time reduction was seen for client devices following the commute path provided in a communication from the client device. Client devices that leave the provided commute path after a commute modification is successfully made may have payments processed regardless of impact due to the client devices' actions.

In operation 728, notification of the commute modifications are sent to the various client devices. In certain embodiments, additional notifications may be sent periodically if a commute modification is under analysis for more than a threshold amount of time. A communication status update may be provided to a client device after the payment is processed for a verified commute modification, when a system has determined that no commute modification is to be implemented that benefits the client device receiving a message, or if a system determines that a device has deviated from a commute path or otherwise has revoked the initial bid. For first client device 702 of FIG. 7 operation 730 involves receiving a notification of a commute modification. This may be accompanied by an estimated commute time reduction, path instructions with lane changes and driving directions, or any other such supplemental information.

If second client device 704 offers to take a slower commute path and this offer is accepted by the system, the notification in operation 732 may provide instructions on how to proceed to receive a payment or point reward. An application operating on second client device 704 may then begin tracking the movement of second client device 704 or any other devices associated with the same account to verify that the instructions are followed. These may be instructions to take any alternate route, or instructions not to use a commute lane. A payment or credit to the account may be processed after the tracking system determines that the instructions have been followed during a timing window specified by the system.

FIGS. 8 and 9 illustrate aspects of user interface elements according to some example embodiments. FIG. 8 depicts an example mobile device that may be a client device as described herein, executing a mobile operating system (e.g., iOS™, Android™, Windows® Phone, or other mobile operating systems).

In one embodiment, the mobile device 800 may include a touchscreen that may receive tactile information from a user 802. For instance, the user 802 may physically touch 804 the mobile device 800, and in response to the touch 804, the mobile device 800 may determine tactile information such as touch location, touch force, gesture motion, and so forth. In various example embodiments, the mobile device 800 may display a home screen 806 that the user 802 of the mobile device 800 may use to launch applications and otherwise manage the mobile device 800. In various example embodiments, the home screen 806 may provide status information such as battery life, connectivity, or other hardware status. The home screen 806 may also include a plurality of icons that may be activated to launch applications, for example, by touching 804 the area occupied by the icon. Similarly, other user interface elements may be activated by touching 804 an area occupied by a particular user interface element. In this manner, the user 802 may interact with the applications.

Many varieties of applications (also referred to as “apps”) may be executing on the mobile device 800. The applications may include native applications (e.g., applications programmed in Objective-C running on iOS™ or applications programmed in Java running on Android™), mobile web applications (e.g., HTML5), or hybrid applications (e.g., a native shell application that launches an HTML5 session). In a specific example, the mobile device 800 may include applications such as a web client 112 or a commute modification client 116, along with other applications such as messaging, location services, multimedia, and other applications.

FIG. 9 then illustrates an example user interface for interacting with a commute modification system using a client device 900. The example interface illustrated with client device 900 includes a map area 906, a user interface area 902, and a bid interface area 904. User interface area 902 may be used to provide communication updates or display settings for a current communication to a commute modification server computer. Bid interface area 904 may be used to display a current bid value, a default bid value, interface options for adjusting bid amounts, feedback on timing windows and limitations on changes to a bid, or any other such information.

Map area 906 illustrates a commute path having starting position 910 that is associated with a current position of client device 900, and a destination position 912. Path 908 may be a user-provided path, and a user may indicate that the user does not wish to deviate from this path. In other embodiments, a touch interface may be used to input any details associated with desired paths, undesired paths, or any other such information. This input information may then be communicated to a commute modification server as described above. After such a communication, updates may be presented in user interface area 902 as then are received at client device 900 from a commute modification server. If an accepted bid is associated with an alternate route, details on the route provided with commute modifications may be presented in map area 906. In other embodiments, other user interfaces with any information relevant to reducing a user's commute time in conjunction with commute modifications may be shown.

Additionally, if a client device is offering to take a slower commute path in exchange for a credit or point value, the user interface may provide notification of this offer, details or limitations, a notification that the client device is actively being tracked, updated path directions, or any other such information. In such an embodiment, user interface area 902 may additionally include information about time remaining in a window, alerts regarding non-compliance with expected movement, notification that a payment or points reward has been processed, or any other such information.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., at least one processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device while yet another combination produces a server computer for use within a cloud computing architecture. Not all combinations of such software and hardware architectures are presented here as those of skill in the art can readily understand how to implement the concepts contained in the present disclosure in different contexts from the disclosure contained herein.

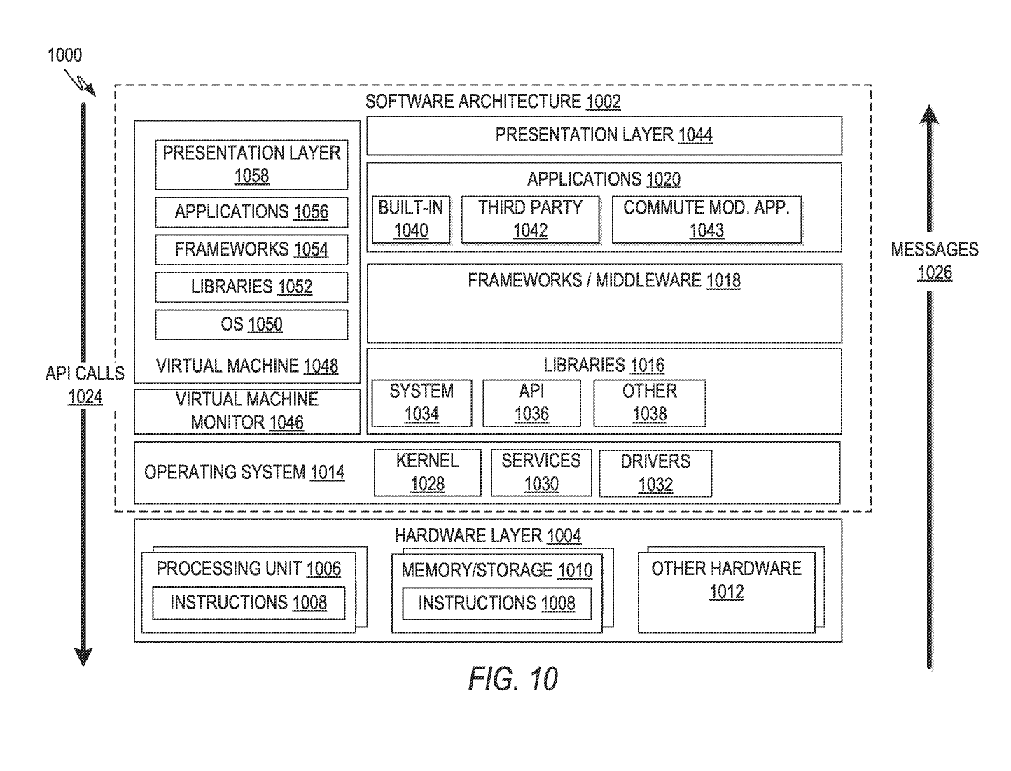

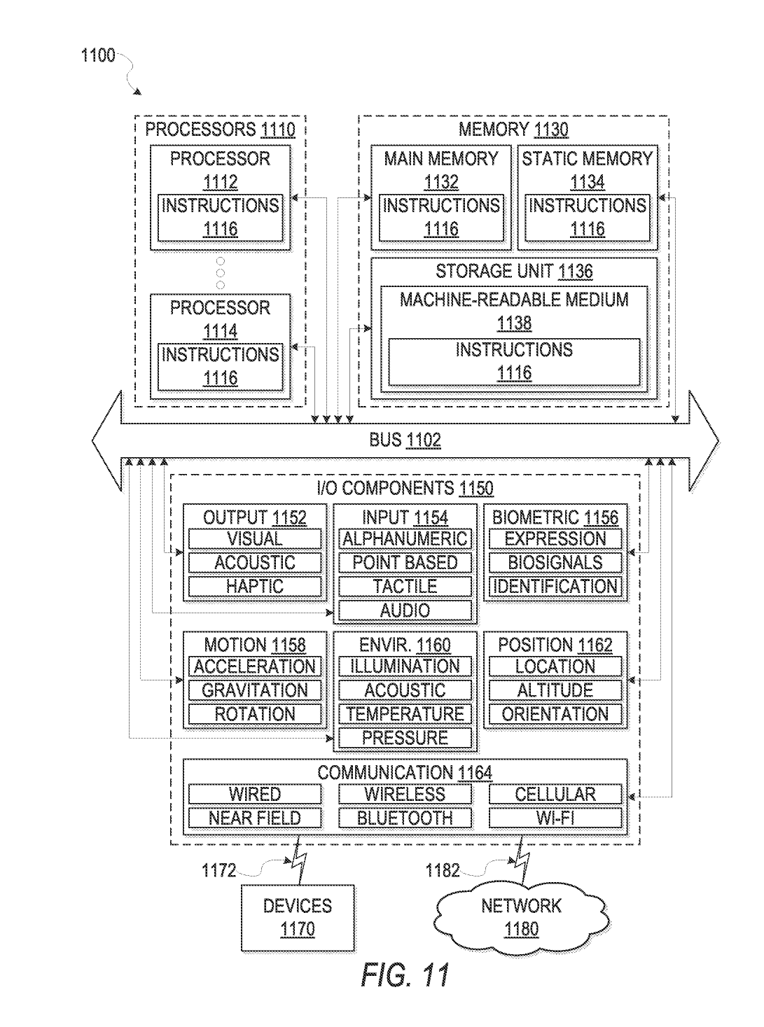

FIG. 10 is a block diagram 1000 illustrating a representative software architecture 1002, which may be used in conjunction with various hardware architectures herein described. FIG. 10 is merely a non-limiting example of a software architecture and it will be appreciated that many other architectures may be implemented to facilitate the functionality described herein. The software architecture 1002 may be executing on hardware such as machine 1100 of FIG. 11 that includes, among other things, processors 1110, memory 1130, and input/output (I/O) components 1150. A representative hardware layer 1004 is illustrated and can represent, for example, the machine 1100 of FIG. 11. The representative hardware layer 1004 comprises one or more processing units 1006 having associated executable instructions 1008. Executable instructions 1008 represent the executable instructions of the software architecture 1002. For example any hardware device including traffic devices 130, client devices 110, servers 120, 122, 140, and 124, or any element of network 104 may be implemented as hardware executing software similar to software architecture 1002. Hardware layer 1004 also includes memory and/or storage modules 1010, which also have executable instructions 1008. Hardware layer 1004 may also comprise other hardware as indicated by 1012, which represents any other hardware of the hardware layer 1004, such as the other hardware illustrated as part of machine 1100.

In the example architecture of FIG. 10, the software architecture 1002 may be conceptualized as a stack of layers where each layer provides particular functionality. For example, the software architecture 1002 may include layers such as an operating system 1014, libraries 1016, frameworks/middleware 1018, applications 1020, and presentation layer 1044. Operationally, the applications 1020 and/or other components within the layers may invoke API calls 1024 through the software stack and receive a response, returned values, and so forth illustrated as messages 1026 in response to the API calls 1024. The layers illustrated are representative in nature and not all software architectures have all layers. For example, some mobile or special purpose operating systems may not provide a frameworks/middleware 1018 layer, while others may provide such a layer. Other software architectures may include additional or different layers.

The operating system 1014 may manage hardware resources and provide common services. The operating system 1014 may include, for example, a kernel 1028, services 1030, and drivers 1032. The kernel 1028 may act as an abstraction layer between the hardware and the other software layers. For example, the kernel 1028 may be responsible for memory management, processor management (e.g., scheduling), component management, networking, security settings, and so on. The services 1030 may provide other common services for the other software layers. The drivers 1032 may be responsible for controlling or interfacing with the underlying hardware. For instance, the drivers 1032 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1016 may provide a common infrastructure that may be utilized by the applications 1020 and/or other components and/or layers. The libraries 1016 typically provide functionality that allows other software modules to perform tasks in an easier fashion than to interface directly with the underlying operating system 1014 functionality (e.g., kernel 1028, services 1030, and/or drivers 1032). The libraries 1016 may include system libraries 1034 (e.g., C standard library) that may provide functions such as memory allocation functions, string manipulation functions, mathematic functions, and the like. In addition, the libraries 1016 may include API libraries 1036 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 1016 may also include a wide variety of other libraries 1038 to provide many other APIs to the applications 1020 and other software components/modules.

The frameworks/middleware 1018 (also sometimes referred to as middleware) may provide a higher-level common infrastructure that may be utilized by the applications 1020 and/or other software components/modules. For example, the frameworks/middleware 1018 may provide various graphic user interface (GUI) functions, high-level resource management, high-level location services, and so forth. The frameworks/middleware 1018 may provide a broad spectrum of other APIs that may be utilized by the applications 1020 and/or other software components/modules, some of which may be specific to a particular operating system or platform.

The applications 1020 include built-in applications 1040 and/or third party applications 1042. Examples of representative built-in applications 1040 may include, but are not limited to, a contacts application, a browser application, a book reader application, a location application, a media application, a messaging application, and/or a game application. Third party applications 1042 may include any of the built in applications 1040 as well as a broad assortment of other applications. In a specific example, the third party application 1042 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 1042 may invoke the API calls 1024 provided by the mobile operating system such as operating system 1014 to facilitate functionality described herein. Certain embodiments may particularly include a commute modification application 1043, which may be similar to commute modification client 116 of FIG. 1. In certain embodiments, commute modification application 1043 may be used to present a user interface similar to the interface illustrated by FIG. 9, or may be used to implement any commute modification operations associated with a client device as described anywhere herein.

The applications 1020 may utilize built in operating system functions (e.g., kernel 1028, services 1030, and/or drivers 1032), libraries (e.g., system 1034, APIs 1036, and other libraries 1038), and frameworks/middleware 1018 to create user interfaces to interact with users of the system. Alternatively, or additionally, in some systems, interactions with a user may occur through a presentation layer, such as presentation layer 1044. In these systems, the application/module “logic” can be separated from the aspects of the application/module that interact with a user.

Some software architectures utilize virtual machines. In the example of FIG. 10, this is illustrated by virtual machine 1048. A virtual machine creates a software environment where applications/modules can execute as if they were executing on a hardware machine (such as the machine of FIG. 11, for example). A virtual machine is hosted by a host operating system (operating system 1014 in FIG. 10) and typically, although not always, has a virtual machine monitor 1046, which manages the operation of the virtual machine 1048 as well as the interface with the host operating system (i.e., operating system 1014). A software architecture executes within the virtual machine 1048 such as an operating system 1050, libraries 1052, frameworks/middleware 1054, applications 1056, and/or presentation layer 1058. These layers of software architecture executing within the virtual machine 1048 can be the same as corresponding layers previously described or may be different.

### Example Machine Architecture and Machine-Readable Medium

FIG. 11 is a block diagram illustrating components of a machine 1100, according to some example embodiments, able to read instructions (e.g., processor-executable instructions) from a machine-readable medium (e.g., a non-transitory machine-readable storage medium) and perform any one or more of the methodologies discussed herein. Specifically, FIG. 11 shows a diagrammatic representation of the machine 1100 in the example form of a computer system, within which instructions 1116 (e.g., software, a program, an application, an applet, an app, or other executable code) for causing the machine 1100 to perform any one or more of the methodologies discussed herein may be executed. For example the instructions 1116 may cause the machine 1100 to execute elements of the diagrams of FIG. 2 or 7, or of any method described herein. Additionally, or alternatively, the instructions 1116 may implement communication module 310, analysis module 320, control update module 330, database module 350, and so forth. In some embodiments, these modules may be distributed across multiple machines as a virtual or distributed implementation of the respective module. The instructions 1116 transform the general, non-programmed machine into a particular machine programmed to carry out the described and illustrated functions in the manner described. In alternative embodiments, the machine 1100 operates as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a vehicle integrated computer, a server computer, a client computer, a personal computer (PC), a tablet computer, a laptop computer, a netbook, a wearable device, or any machine capable of executing the instructions 1116, sequentially or otherwise, that specify actions to be taken by machine 1100. Further, while only a single machine 1100 is illustrated, the term “machine” shall also be taken to include a collection of machines 1100 that individually or jointly execute the instructions 1116 to perform any one or more of the methodologies discussed herein.

The machine 1100 may include processors 1110, memory 1130, and I/O components 1150, which may be configured to communicate with each other such as via a bus 1102. In an example embodiment, the processors 1110 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, processor 1112 and processor 1114 that may execute instructions 1116. The term “processor” is intended to include multi-core processor that may comprise two or more independent processors (sometimes referred to as “cores”) that may execute instructions contemporaneously. Although FIG. 11 shows multiple processors 1110, the machine 1100 may include a single processor with a single core, a single processor with multiple cores (e.g., a multi-core process), multiple processors with a single core, multiple processors with multiples cores, or any combination thereof.

The memory 1130 may include a main memory 1132, static memory 1134, or other memory storage, and a storage unit 1136, both accessible to the processors 1110 such as via a bus 1102. In some embodiments, the storage unit 1136, main memory 1132, and static memory 1134 store the instructions 1116 embodying any one or more of the methodologies or functions described herein. In other embodiments, the instructions 1116 may also reside, completely or partially, within the main memory 1132, within the storage unit 1136, within at least one of the processors 1110 (e.g., within the processor's cache memory), or any suitable combination thereof, during execution thereof by the machine 1100. Accordingly, the main memory 1132, the storage unit 1136, and the memory of processors 1110 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 1116. The term “machine-readable medium” shall also be taken to include any medium, or combination of multiple media, that is capable of storing instructions (e.g., instructions 1116) for execution by a machine (e.g., machine 1100), such that the instructions, when executed by one or more processors of the machine 1100 (e.g., processors 1110), cause the machine 1100 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1150 may include a wide variety of components to receive input, provide output, produce output, transmit information, exchange information, capture measurements, and so on. The specific I/O components 1150 that are included in a particular machine will depend on the type of machine. For example, portable machines such as mobile phones will likely include a touch input device or other such input mechanisms, while a headless server machine will likely not include such a touch input device. It will be appreciated that the I/O components 1150 may include many other components that are not shown in FIG. 11. The I/O components 1150 are grouped according to functionality merely for simplifying the following discussion and the grouping is in no way limiting. In various example embodiments, the I/O components 1150 may include output components 1152 and input components 1154. The output components 1152 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1154 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 1150 may include biometric components 1156, motion components 1158, environmental components 1160, or position components 1162 among a wide array of other components. For example, the biometric components 1156 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1158 may include acceleration sensor components (e.g., accelerometer), gravitation sensor components, rotation sensor components (e.g., gyroscope), and so forth. The environmental components 1160 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1162 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1150 may include communication components 1164 operable to couple the machine 1100 to a network 1180 or devices 1170 via coupling 1182 and coupling 1172, respectively. For example, the communication components 1164 may include a network interface component or other suitable device to interface with the network 1180. In further examples, communication components 1164 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1170 may be another machine or any of a wide variety of peripheral devices (e.g., a peripheral device coupled via a USB).

Moreover, the communication components 1164 may detect identifiers or include components operable to detect identifiers. For example, the communication components 1164 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1164, such as location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 1180 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 1180 or a portion of the network 1180 may include a wireless or cellular network and the coupling 1182 may be a Code Division Multiple Access (CDMA) connection, a Global System for Mobile communications (GSM) connection, or other type of cellular or wireless coupling. In this example, the coupling 1182 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 1116, embodied as processor executable instructions, can provide an algorithmic and programmatic expression of any above-referenced modules or structures and enable the modules to perform the methodologies described herein. The instructions 1116 may be transmitted or received over the network 1180 using a transmission medium via a network interface device (e.g., a network interface component included in the communication components 1164) and utilizing any one of a number of well-known transfer protocols (e.g., Hypertext Transfer Protocol (HTTP)). Similarly, the instructions 1116 may be transmitted or received using a transmission medium via the coupling 1172 (e.g., a peer-to-peer coupling) to devices 1170. The term “transmission medium” shall be taken to include any intangible medium that is capable of storing, encoding, or carrying instructions 1116 for execution by the machine 1100, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
receiving, at a server computer from a first client device, a first communication, wherein the first communication comprises a bid value and a commute path;
analyzing, by the server computer, the first communication to identify an available commute modification associated with the commute path;
communicating, by the server computer, with at least a first traffic device regarding the available commute modification;
verifying, by the server computer, a change in a commute value associated with the available commute modification and the first traffic device; and
sending, from the server computer, a commute modification message to the first client device following verification of the change in the commute value.

2. The method of claim 1 wherein the first client device comprises:
a smartphone.

3. The method of claim 1 wherein the first client device comprises:
an automobile navigation computer.

4. The method of claim 3 wherein the commute path comprises a current vehicle position and a destination position.

5. The method of claim 4 wherein analyzing the first communication to identify the available commute modification comprises:
identifying a first set of navigation directions associated with the commute path;
identifying a first set of traffic lights associated with the first set of navigation directions; and
determining a set of acceptable timing parameters associated with the first set of traffic lights.

6. The method of claim 5 wherein analyzing the first communication to identify the available commute modification comprises:
identifying a plurality of navigation directions associated with the commute path;
accessing estimated travel times for each of the navigation directions of the plurality of navigation directions; and
selecting the first set of navigation directions based on an estimated travel time associated with the first set of navigation directions.

7. The method of claim 6 wherein analyzing the first communication to identify the available commute modification further comprises:
analyzing the set of acceptable timing parameters, the current vehicle position, and the first set of navigation directions to estimate a timing impact associated with one or more timing changes determined from the set of acceptable timing parameters; and
selecting a first set of timing changes from the one or more timing changes based on the timing impact associated with the first set of timing changes.

8. The method of claim 7 wherein communicating with at least the first traffic device regarding the available commute modification comprises communicating the first set of timing changes to the first set of traffic lights.

9. The method of claim 8 further comprising:
receiving the first communication with a plurality of communications, each communication of the plurality of communications comprising an associated bid value and a corresponding commute path;
wherein analyzing the first communication to identify the available commute modification associated with the commute path comprises identifying a set of complementary commute modifications including the available commute modification, wherein the set of complementary commute modifications are determined at least in part based on the aggregate bid values of a subset of the plurality of communications that receive a threshold timing benefit from the set of complementary commute modifications.

10. The method of claim 8 further comprising:
receiving, at the server computer from a second client device, a second communication, wherein the second communication comprises a second bid value and a second commute path;
analyzing the second communication to identify a second available commute modification associated with the second commute path;
analyzing the second commute path to determine that the second available commute modification is not complementary with the available commute modification; and
analyzing the bid value and the second bid value to determine that a first set of aggregate bids complementary with the available commute modification is larger than a second set of aggregate bids complementary with the second available commute modification.

11. The method of claim 10 further comprising:
sending a bid failure message to the second client device following verification of the change in the commute value.

12. The method of claim 8 further comprising:
processing a payment associated with the bid value after sending the commute modification message to the first client device following verification of the change in the commute value.

13. A server system comprising:
a communication module operating on one or more processors configured to receive, from a first client device, a first communication, and storing the first communication in a memory, wherein the first communication comprises a bid value and a commute path;
an analysis module operating on the one or more processors configured to analyze the first communication to identify an available commute modification associated with the commute path; and
a control update module operating on the one or more processors and configured to:
communicate with at least a first traffic device regarding the available commute modification;
verify a change in a commute value associated with the available commute modification and the first traffic device; and
initiate transmission of a commute modification message to the first client device following verification of the change in the commute value.

14. The system of claim 13 wherein the commute path comprises a current vehicle position and a destination position; and
wherein the analysis module is configured to analyze the first communication to:
identify the available commute modification by:
identifying a first set of navigation directions associated with the commute path; and
identifying a first set of traffic lights associated with the first set of navigation directions; and
determine a set of acceptable timing parameters associated with the first set of traffic lights.

15. The system of claim 14 wherein the analysis module is further configured to analyze the first communication to identify the available commute modification by:
identifying a plurality of navigation directions associated with the commute path;
accessing estimated travel times for each of the navigation directions of the plurality of navigation directions; and
selecting the first set of navigation directions based on an estimated travel time associated with the first set of navigation directions.

16. The system of claim 15 wherein the analysis module is configured to analyze the first communication to identify the available commute modification by:
analyzing the set of acceptable timing parameters, the current vehicle position, and the first set of navigation directions to estimate a timing impact associated with one or more timing changes determined from the set of acceptable timing parameters; and
selecting a first set of timing changes from the one or more timing changes based on the timing impact associated with the first set of timing changes.

17. The system of claim 16 wherein the control update module is configured to communicate with at least the first traffic device regarding the available commute modification by communicating the first set of timing changes to the first set of traffic lights.

18. A non-transitory computer readable medium comprising computer readable instructions that, when executed by one or more processors, cause a server system to perform a set of operations comprising:
receiving, from a first client device, a first communication, wherein the first communication comprises a bid value and a commute path;
analyzing the first communication to identify an available commute modification associated with the commute path;
communicating with at least a first traffic device regarding the available commute modification;
verifying a change in a commute value associated with the available commute modification and the first traffic device; and
sending a commute modification message to the first client device following verification of the change in the commute value.

19. The non-transitory computer readable medium of claim 18, wherein the set of operations further comprises:
receiving the first communication with a plurality of communications, each communication of the plurality of communications comprising an associated bid value and a corresponding commute path;
analyzing the first communication with each other communication of the plurality of communications to identify a set of complementary commute modifications including the available commute modification, wherein the set of complementary commute modifications are determined at least in part based on a total bid value of a subset of the plurality of communications that receive a threshold timing benefit from the set of complementary commute modifications.

20. The non-transitory computer readable medium of claim 18, wherein the set of operations further comprises:
receiving, from a second client device, a second communication, wherein the second communication comprises a second bid value and a second commute path;
analyzing the second communication to identify a second available commute modification associated with the second commute path;
analyzing the second commute path to determine that the second available commute modification is not complementary with the available commute modification; and
analyzing the bid value and the second bid value to determine that a first set of aggregate bids complementary with the available commute modification is larger than a second set of aggregate bids complementary with the second available commute modification.
